(19) United States
(12) Patent Application Publication
(10) Pub. No.: US 2009/0213800 A1
(43) Pub. Date: Aug. 27, 2009

(54) Device and Method for Controlling State in Cellular System

(75) Inventors: Kyung-Seok Lee, Daejeon (KR); Soo-Jung Jung, Daejeon (KR); Byung-Han Ryu, Daejeon (KR); Kang-Hee Kim, Daejeon (KR); Jung-Im Kim, Daejeon (KR); Hyun-Hwa Seo, Daejeon (KR); Mu-Yong Shin, Daejeon (KR); Geon-Min Yeo, Daejeon (KR); Soon-Yong Lim, Daejeon (KR); Jae-Heung Kim, Daejeon (KR); Il-Soon Jang, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTIT, Daejeon (KR)

(21) Appl. No.: 11/922,312

(22) PCT Filed: Jun. 15, 2006
(86) PCT No.: PCT/KR2006/002292

§ 371 Date: Mar. 23, 2009

(30) Foreign Application Priority Data
Jun. 15, 2005 (KR) 10-2005-0051523
Jun. 14, 2006 (KR) 10-2006-0053527

(51) Int. Cl. H04W 40/12; H04L 12/56

(52) U.S. Cl. 370/329; 370/389

(57) ABSTRACT

A terminal state controlling method and apparatus are provided. The terminal state includes a connected state and an idle state, and the connected state includes an active state and a dormant state. The active state includes a scheduling-ON state and a scheduling-OFF state. In the state controlling apparatus, a radio resource control (RRC) layer controls a transition between the active state and the dormant state, and a media access control (MAC) layer controls a transition between the scheduling-ON state and the scheduling-OFF state.

### BACKGROUND OF THE INVENTION

(a) Field of the Invention

The present invention relates to a state controlling apparatus and method in a cellular system. More particularly, the present invention relates to a terminal state controlling apparatus and method in a 3rd Generation Partnership Project (3GPP) system.

(b) Description of the Related Art

In a cellular system, a terminal has two types of operational modes, an idle mode for saving terminal power and network resource and for providing a seamless service and a connected mode for data communication between the terminal and the base station. A transition between these two operational modes is achieved by a control of a radio resource control (hereinafter, referred to as “RRC”) layer belonging to a network layer in a protocol structure. Accordingly, a delay may be generated on the transmission of control instructions. In addition, the control instruction delay may generate a control channel allocation and recovery delay, where the control channel is involved in a channel allocation and a shared channel allocation for data transmission in a packet system. Since the channel allocation and recovery operation of the connected mode-terminal is performed by all terminals in the same manner, a control physical channel may be continuously maintained even when there are a small number of packet data to be transmitted or a desired quality of service (QoS) of a packet data is low, thereby increasing power consumption. In a conventional connection for terminal-initial access and paging processes, the random access process is performed through the same algorithm, and accordingly, the same delay may be generated. Thus, a priority-connection may be not performed.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a state controlling apparatus and method in a cellular system having advantages of determining a terminal state transition according to packet service characteristics and an available radio resource state.

An exemplary embodiment of the present invention provides a terminal state controlling method including transiting a terminal into a dormant state when packet data are not received from the terminal in an active state for a predetermined time, and transiting the terminal into an idle state when packet data to be transmitted to the terminal in the dormant state are not received for a predetermined time. At this time, the active state and the dormant state are states in which the uplink and downlink traffic channels are allocated to the terminal, the active state being a state in which the terminal maintains a synchronization to the uplink and downlink traffic channels and the dormant state being a state in which the terminal breaks the synchronization to the uplink and downlink traffic channels. The idle state is a state in which the uplink and downlink traffic channels are not allocated to the terminal. The dormant state may be a state in which the terminal discontinuously receives the packet data through the downlink traffic channel.

Another embodiment of the present invention provides a terminal state controlling method transiting a terminal into a scheduling-OFF state when packet data are not received from the terminal in a scheduling-ON state for a predetermined time, and transiting a terminal into a dormant state when packet data are not received from the terminal in the scheduling-OFF state for a predetermined time. At this time, the scheduling-ON state, the scheduling-OFF state, and the dormant states are states in which uplink and downlink traffic channels are allocated to the terminal, the scheduling-ON state being a state in which the uplink and downlink traffic channel resources are allocated to the terminal according to the terminal-supportable QoS, the scheduling-OFF state being a state in which the terminal discontinuously transmits/receives the packet data through the uplink and downlink traffic channels, and the dormant state being a state in which the terminal breaks a synchronization to the uplink and downlink traffic channels.

Meanwhile, the terminal state controlling method may include: allocating a state transition channel to the terminal in the scheduling-OFF state; receiving a state transition request for transiting the terminal from the scheduling-OFF state to the scheduling-ON state; and transiting the terminal from the scheduling-OFF state to the scheduling-ON state when the state transition request is received. Meanwhile, the terminal state controlling method may include: determining a random access channel resource according to the terminal-supportable QoS; informing the determined random access channel resource of the terminal through a paging channel; receiving a transition request into the active state from the terminal in the dormant state through the determined random access channel resource; and transiting the terminal from the dormant state to the scheduling-ON state or the scheduling-OFF state when the transition request is received.

### BRIEF DESCRIPTION OF THE DRAWINGS

FIG. 1 is a schematic view of a cellular system according to an exemplary embodiment of the present invention.

FIG. 2 is a block diagram showing a protocol structure of a state controlling apparatus according to an exemplary embodiment of the present invention.

FIG. 3 is a block diagram showing a state controlling apparatus according to an exemplary embodiment of the present invention.

FIG. 4 illustrates a terminal state managed by a cellular system according to an exemplary embodiment of the present invention.

FIG. 5 illustrates a terminal active state managed by a cellular system according to an exemplary embodiment of the present invention.

FIG. 6 is a flowchart showing how a state controlling apparatus transits a terminal from an active state to a dormant state according to an exemplary embodiment of the present invention.

FIG. 7 is a flowchart showing how a state controlling apparatus transits a terminal from a dormant state to an active state according to an exemplary embodiment of the present invention.

FIG. 8 is a flowchart showing how a state controlling apparatus transits a terminal from a dormant state to an active state according to another exemplary embodiment of the present invention.

FIG. 9 is a flowchart showing how a state controlling apparatus transits a terminal from a scheduling-ON state to a scheduling-OFF state according to another exemplary embodiment of the present invention.

FIG. 10 is a flowchart showing how a state controlling apparatus transits a terminal from a scheduling-OFF state to a scheduling-ON state according to an exemplary embodiment of the present invention.

FIG. 11 is a flowchart showing how a state controlling apparatus transits a terminal from a scheduling-OFF state to a scheduling-ON state according to another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims which follow, unless explicitly described to the contrary, the word “comprise” or variations such as “comprises” or “comprising” will be understood to imply the inclusion of stated elements but not the exclusion of any other elements.

A cellular system according to an exemplary embodiment of the present invention uses a pilot channel, a paging channel, a state transition channel, a random access channel (RACH), a downlink traffic channel, and a uplink traffic channel.

The pilot channel is a downlink control channel used such that the terminal achieves synchronization with the base station.

The paging channel is a downlink control channel used such that the base station pages the terminal or transmits an instruction to the terminal.

The state transition channel is a bi-directional control channel used such that the base station exchanges state transition information with the terminal.

The random access channel is a uplink control channel used for the terminal to broadcast information to the base station by competing other terminals through a backoff time determined according to a regular rule.

The downlink traffic channel is a data channel used such that the base station transmits traffic data to the terminal and the uplink traffic channel is a data channel used such that the terminal transmits traffic data to the base station.

That is, the cellular system according to an exemplary embodiment of the present invention uses the pilot channel, paging channel, state control channel, and random access channel as the control channel and uses the downlink traffic channel and uplink data channel as the data channel.

Now, a state controlling method and apparatus of a cellular system according to an exemplary embodiment of the present invention will be described with reference to the accompanying figures.

FIG. 1 is a schematic view of a cellular system according to an exemplary embodiment of the present invention.

As shown in FIG. 1, a cellular system according to an exemplary embodiment of the present invention includes a core network 100 and at least one wireless network subsystem 200a, 200b and the series of wireless network subsystems 200a, 200b are connected to each other through an interface, and accordingly, form a wireless access network 200. Such a wireless access network 200 is connected to the core network 100. Each wireless network subsystem 200a, 200b includes a wireless network controller 210 and at least one base station 220 under the control of the wireless network controller 210, and the respective base stations 220 manage at least one cell (not shown). The respective wireless network subsystems 200a, 200b may have the wireless network controllers 210 connected to each other through the interface. An inter-cell terminal 300 may configure a radio channel by using a radio resource provided by a corresponding base station 220, and may perform a data communication when connected to the wireless access network 200 through the corresponding base station 220.

Dislike FIG. 1, the cellular system may exclude the wireless network controller 210. In this case, the radio resource control functions of the wireless network controller 210 may be dividedly performed by the core network 100 and the base station 220.

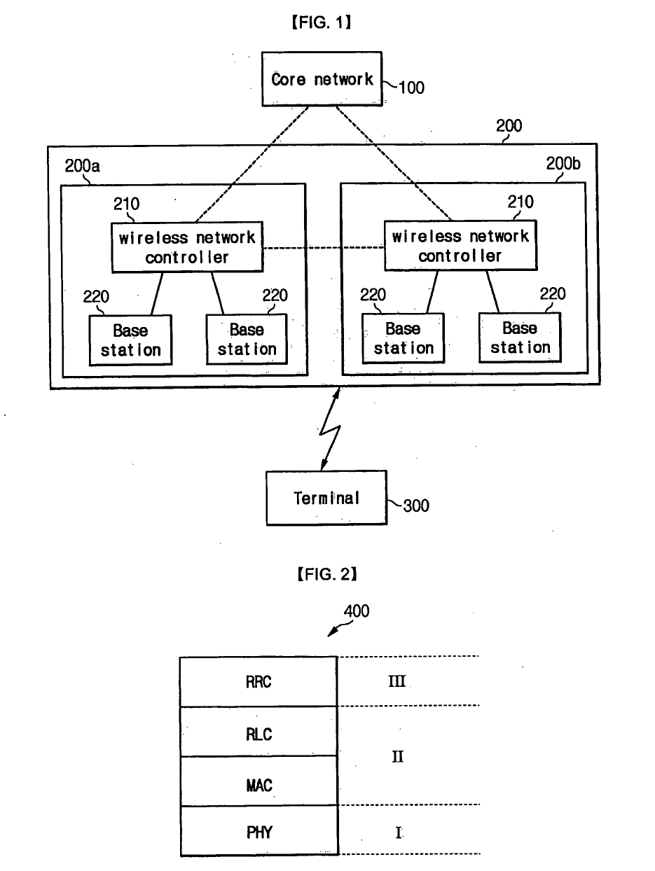

A protocol structure of a state controlling apparatus according to an exemplary embodiment of the present invention will be described with reference to FIG. 2.

FIG. 2 is a block diagram showing a protocol structure of a state controlling apparatus 400 according to an exemplary embodiment of the-present invention.

As shown in FIG. 2, a protocol structure of a state controlling apparatus 400 according to an exemplary embodiment of the present invention includes a physical layer I, a data link layer II, and a network layer III.

The physical layer I measures a radio channel state and supports wireless transmission technology of the cellular system. The data link layer II is placed on the physical layer I and performs a division and re-combination of user data transmitted through the physical layer I, and controls the state of the terminal 300 based on characteristics of packet service of the transmitted data. The data link layer II Includes a media access control layer (hereinafter, a “MAC layer”) and a wireless link control layer. The network layer III sets a wireless bearer such that it performs a transmission of the control instruction and user data between the terminal 300 and the core network 100. The network layer III includes a radio resource control layer (hereinafter, referred to as a “RRC layer”). The RRC layer controls a terminal operational state transition by controlling establishment and termination of a RRC connection, which is a passage for exchanging the control information between the terminal 300 and the core network 100.

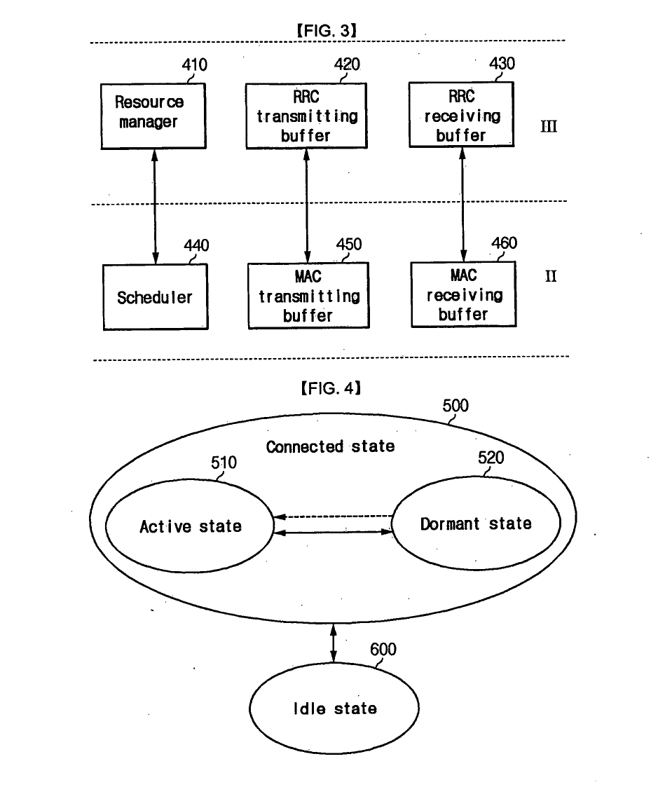

The state controlling apparatus according to an exemplary embodiment of the present invention will be described with reference to FIG. 3.

FIG. 3 is a block diagram showing a state controlling apparatus 400 according to an exemplary embodiment of the present invention. The state controlling apparatus 400 may be formed in the wireless network subsystem 200a, particularly the base station 220 of the wireless network subsystem 200a, and some functions of the state controlling apparatus 400 may be formed in the wireless network controller 210.

As shown in FIG. 3, the state controlling apparatus 400 according to an exemplary embodiment of the present invention includes a resource manager 410, a RRC transmitting buffer 420, and a RRC receiving buffer 430 in the RRC layer III and includes a scheduler 440, a MAC transmitting buffer 450, and a MAC receiving buffer 460 in the MAC layer II.

The RRC transmitting buffer 420 and the MAC transmitting buffer 450 are for storing packet data to be transmitted to the terminal 300. In more detail, the RRC layer III receives packet data to be transmitted to the terminal 300 and stores the same to the RRC transmitting buffer 420. The RRC layer BI transmits the packet data of the RRC transmitting buffer 420 to the MAC layer II. The MAC layer II receives the packet data and stores the same to the MAC transmitting buffer 450, and transmits the stored packet data of the MAC transmitting buffer 450 through the physical layer I to the terminal 300.

The RRC receiving buffer 430 and the MAC receiving buffer 460 are for storing the packet data received from the terminal 300. In more detail, the MAC layer II receives the packet data through the physical layer I from the terminal 300 and stores the same to the MAC receiving buffer 460. The MAC layer II transmits the stored packet data of the MAC receiving buffer 460 to the RRC layer III, and the RRC layer III stores the transmitted packet data to the RRC receiving buffer 430. The stored packet data of the RRC receiving buffer 430 are transmitted through the core network 100 to a destination.

The resource manager 410 manages a resource allocation to the terminal 300, and monitors the RRC transmitting buffer 420 and the RRC receiving buffer 430. The scheduler 440 performs a scheduling for the terminal 300, and monitors the MAC transmitting buffer 450 and the MAC receiving buffer 460.

A terminal state managed by a cellular system according to an exemplary embodiment of the present invention will be described with reference to FIG. 4 and FIG. 5. FIG. 4 illustrates a terminal state managed by a cellular system according to an exemplary embodiment of the present invention and FIG. 5 illustrates a terminal active state managed by a cellular system according to an exemplary embodiment of the present invention.

As shown in FIG. 4 and FIG. 5, according to an exemplary embodiment of the present invention, the terminal state includes a connected state 500 and an idle state 600. The connected state 500 is a state in which the terminal 300 forms a RRC connection with the state controlling apparatus 400. The state controlling apparatus 400 allocates a pilot channel, a paging channel, a random access channel, a downlink traffic channel, and a uplink traffic channel to the terminal 300 in the connected state 500. Accordingly, the terminal 300 in the connected state 500 may access to the pilot channel, paging channel, random access channel, downlink traffic channel, and uplink traffic channel.

The connected state 500 includes an active state 510 and a dormant state 520. The terminal 300 in the active state 510 maintains synchronization to the downlink traffic channel and the uplink traffic channel. Accordingly the terminal 300 in the active state 510 may exchange traffic data with the state controlling apparatus 400. The terminal 300 in the dormant state 520 may reduce power consumption by breaking synchronization to the downlink traffic channel and the uplink traffic channel. In addition, the terminal 300 in the dormant state 520 may further reduce the power consumption by receiving traffic data through the downlink traffic channel according to a discontinuous reception (DRX) scheme. According to the DRX scheme, the terminal 300 may reduce the power consumption because the terminal 300 accesses to the downlink traffic channel at a time slot negotiated with the state controlling apparatus 400. The terminal 300 in the dormant state 520 uses a random access channel so as to transmit control information to the state controlling apparatus 400. The state controlling apparatus 400 uses a paging channel so as to transmit control information to the terminal 300 in the dormant state 520.

The active state 510 includes a scheduling-ON state 511 and a scheduling-OFF state 512. The state controlling apparatus 400 allocates resources of the downlink and uplink traffic channels to the terminal 300 in the scheduling-ON state 511 according to the QoS. That is, the state controlling apparatus 400 performs a scheduling to the plurality of terminals and allocates a radio resource determined according to the QoS to the respective terminals. Meanwhile, the terminal 300 in the scheduling-OFF state 512 operates the control channel and the data channel in the DRX scheme or DTX (discontinuous transmission) scheme. Particularly, the terminal 300 in the scheduling-OFF state 512 uses the downlink traffic channel of the DRX scheme and the uplink traffic channel of the DTX scheme. That is, the terminal 300 In the scheduling-OFF state 512 discontinuously receives traffic data through the downlink traffic channel and discontinuously transmits the same through the uplink traffic channel to the state controlling apparatus 400. Resultantly, the terminal 300 consumes more power in the scheduling-ON state 511 than in the scheduling-OFF state 512. In order to rapidly transit the terminal 300 from the scheduling-OFF state 512 to the scheduling-ON state 511, the state controlling apparatus 400 allocates a state transition channel to the terminal 300 in the scheduling-OFF state 512. The terminal 300 in the scheduling-OFF state 512 may use the state transition channel in the DRX scheme and the DTX scheme.

The terminal 300 in the idle state 600 may not exchange the traffic data with the state controlling apparatus 400 and performs a synchronization to the pilot channel and the paging channel. The terminal 300 in the idle state 600 may access to the random access channel. The state controlling apparatus 400 recovers the downlink and uplink traffic channels from the terminal 300 in the idle state 600 and manages the radio resource. Accordingly, the terminal 300 in the idle state 600 may not maintain synchronization to the downlink and uplink traffic channels, so that it may reduce power consumption.

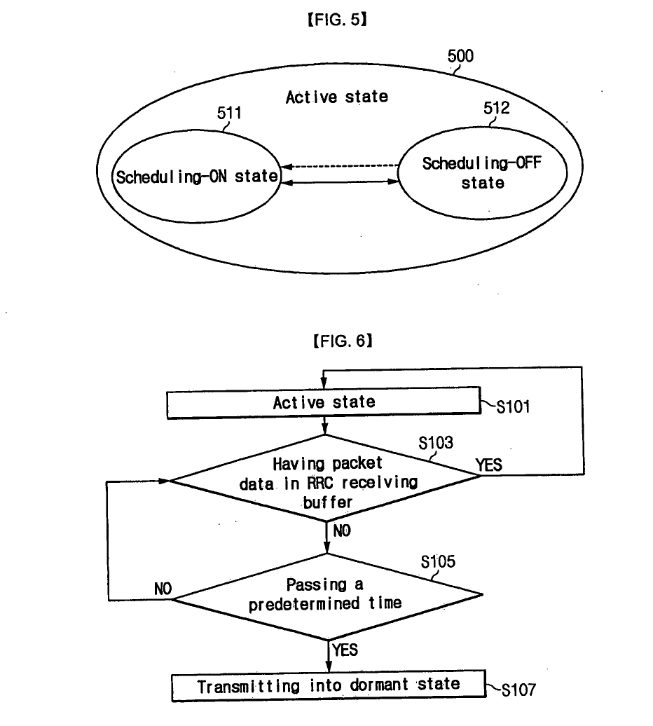

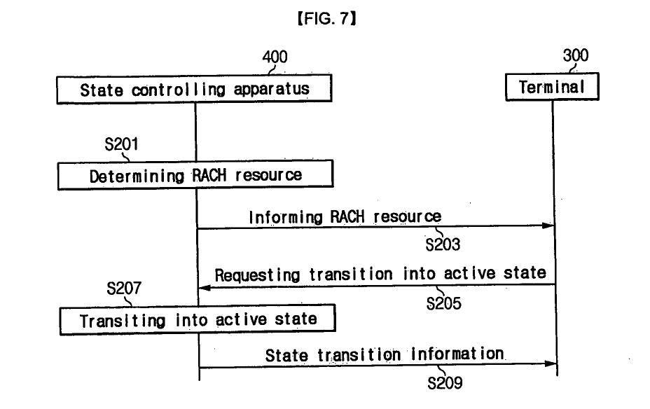

How the state controlling apparatus 400 controls a state of the terminal 300 according to an exemplary embodiment of the present invention will now be described with reference to FIG. 6 to FIG. 11.

First, how the state controlling apparatus 400 transits the terminal 300 from the active state 510 to the dormant state 520 will be described with reference to FIG. 6.

FIG. 6 is a flowchart showing how a state controlling apparatus 400 transits a terminal from an active state 510 to a dormant state 520 according to an exemplary embodiment of the present invention. As described above, the active state 510 and the dormant state 520 are both a sub-state of the connected state 500, and such a connected state 500 has a session established to provide a packet service between the terminal 300 and the wireless network subsystem 200a.

For description of FIG. 6, the state of the terminal 300 is assumed as the active state 510 (S101). The resource manager 410 allocates the downlink and uplink traffic channels to the terminal 300 in the active state 510.

The resource manager 410 monitors the RRC receiving buffer 430, determines that the RRC receiving buffer 430 is empty for a predetermined time (S103, S105), and transits the terminal 300 from the active state 510 to the dormant state 520 (S107). The resource manager 410 provides state transition information to the terminal 300 while it transits the terminal 300 to the dormant state 520, and accordingly, it allows the corresponding terminal 300 to break synchronization to the uplink traffic channel and allocates the discontinuous time slots of the downlink traffic channel to the corresponding terminal 300. Accordingly, the transited terminal 300 in the dormant state 520 may receive traffic data discontinuously through the downlink traffic channel. However, it may not perform a synchronization to the uplink traffic channel, and accordingly, it may not transmit traffic data to the state controlling apparatus 400.

In addition, the resource manager 410 may transit the terminal 300 to the dormant state 520 because it is difficult to allocate a radio resource due to a deteriorated wireless environment between the terminal 300 and the base station 220, or may transit the terminal 300 to the dormant state 520 for other reasons.

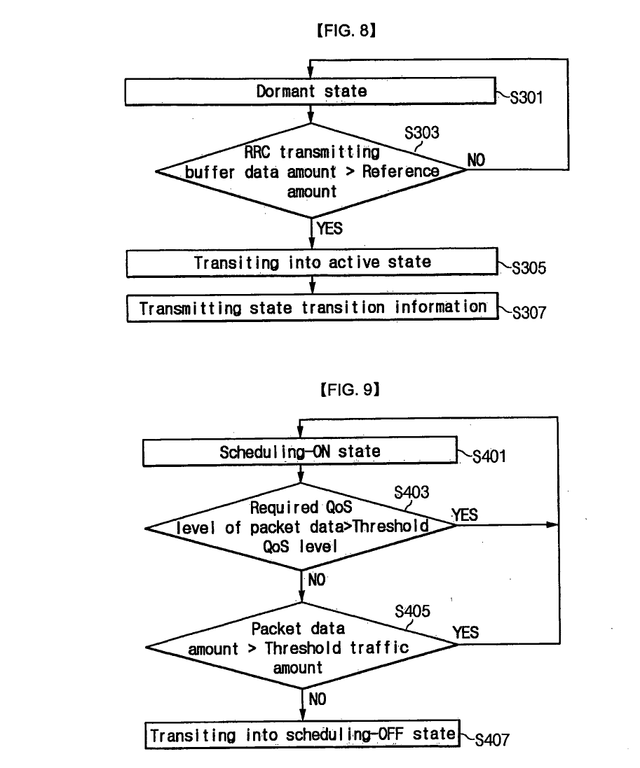

How the state controlling apparatus 400 transits the terminal 300 from the dormant state 520 to the active state 510 will now be described with reference to FIG. 7 and FIG. 8.

FIG. 7 is a flowchart showing how a state controlling apparatus transits a terminal 300 from a dormant state 520 to an active state 510 according to an exemplary embodiment of the present invention. FIG. 7 illustrates a method for requesting a state transition to the state controlling apparatus 400 through the random access channel when the state controlling apparatus 400 allows the terminal 300 to be transited from the dormant state 520 to the active state 510.

First, the resource manager 410 determines a resource of the random access channel according to the terminal-supportable QoS (S201). At this time, the resource of the random access channel may be a backoff time or the like.

The resource manager 410 informs the determined random access channel resource information of the terminal 300 through the paging channel (S203).

The terminal in the dormant state 520 requests the resource manager 410 to transit the terminal to the active state 510 through the informed random access channel (S205).

And then, the resource manager 410 transits the corresponding terminal 300 to the active state 510 (S207). The resource manager 410 transmits state transition information through the paging channel to the terminal 300 while transiting the terminal 300 to the active state 510 (S209), and accordingly, it allows the terminal 300 to perform synchronization to the uplink traffic channel.

FIG. 8 is a flowchart showing how a state controlling apparatus transits a terminal from a dormant state 520 to an active state 510 according to another exemplary embodiment of the present invention.

First, the terminal 300 is in the dormant state 520 (S301).

The resource manager 410 monitors the RRC transmitting buffer 420 (S303), determines that the RRC transmitting buffer 420 stores more packet data than a predetermined reference amount and transits the terminal 300 to the active state 510 (S305). The resource manager 410 transmits the state transition information through the paging channel to the terminal 300 while transiting the terminal 300 to the active state 510 (S307) such that the terminal 300 performs a synchronization to the uplink traffic channel.

Next, how the state controlling apparatus 400 transits the terminal 300 from the connected state 500 to the idle state 600 will be described. The resource manager 410 transits the terminal from the connected state 500 to the idle state 600 when the RRC transmitting buffer 420 and the RRC receiving buffer 430 are empty for a predetermined time.

Next, how the state controlling apparatus 400 transits the terminal 300 from the idle state 600 to the connected state 500 will be described. The resource manager 410 confirms that the packet data are input to the RRC transmitting buffer 420 and transits the terminal 300 from the idle state 600 to the connected state 500. Meanwhile, the terminal 300 in the idle state 600 confirms that there is packet data to be transmitted to the state controlling apparatus 400, requests the state controlling apparatus 400 to transit the terminal 300 to the connected state 500 through the random access channel, and is transited to the connected state 500.

As described above, the resource manager 410 controls the state transition between the active state 510 and the dormant state 520 and controls the state transition between the connected state 500 and the idle state 600. The resource manager 410 controls the resource allocation according to the terminal-supportable Qos and thus manages the radio resource.

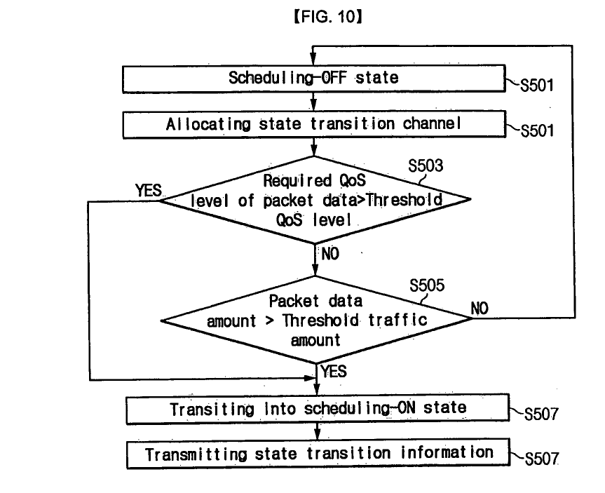

Next, how the state controlling apparatus 400 transits the terminal 300 from the scheduling-ON state 511 to the scheduling-OFF state 512 will be described with reference to FIG. 9.

FIG. 9 is a flowchart showing how a state controlling apparatus 400 transits a terminal 300 from a scheduling-ON state 511 to a scheduling-OFF state 512 according to another exemplary embodiment of the present invention.

First, the terminal 300 is in the scheduling-ON state 511 (S401). At this time, the scheduler 440 allocates resources of the uplink traffic channel and the downlink traffic channel to the terminal 300 in the scheduling-ON state 511 according to the terminal-supportable QoS.

The scheduler 440 determines whether the QoS level of the stored packet data of the MAC transmitting buffer 450 exceeds a predetermined threshold QoS (S403). If the QoS level of the stored packet data of the MAC transmitting buffer 450 exceeds a predetermined threshold QoS, the scheduler 440 maintains the terminal 300 in the scheduling-ON state 511. However, if the QoS level of the stored packet data of the MAC transmitting buffer 450 is lower than the predetermined threshold QoS, the scheduler 440 determines whether the stored packet data amount of the MAC transmitting buffer 450 and the MAC receiving buffer 460 is more than the predetermined threshold traffic amount (S405). If the stored packet data amount of the MAC transmitting buffer 450 and the MAC receiving buffer 460 is more than the predetermined threshold traffic amount, the scheduler 440 maintains the terminal 300 in the scheduling-ON state 511. However, if the stored packet data amount of the MAC transmitting buffer 450 and the MAC receiving buffer 460 is lower than the predetermined threshold traffic amount, it transits the terminal 300 to the scheduling-OFF state 512 (S407). When the stored packet data amount of the MAC transmitting buffer 450 and the MAC receiving buffer 460 is lower than the predetermined threshold traffic amount, the terminal 300 may exchange the packet data with the state controlling apparatus 400 through part of time slots of the downlink and uplink traffic channels. The scheduler 440 controls the corresponding terminal 300 such that the terminal in the scheduling-OFF state 512 discontinuously transmits/receives packet data through the uplink and downlink traffic channels.

When the terminal 300 does not broadcast the packet data, the terminal 300 may be transited from the active state 510 to the dormant state 520. The scheduling-OFF state 512 may utilize a temporary state of such a transition process. That is, the scheduler 440 transits the terminal 300 from the scheduling-ON state 511 to the scheduling-OFF state when the MAC receiving buffer 460 is empty for a predetermined time. Thereafter, when the MAC receiving buffer 460 is empty for a predetermined time, the RRC receiving buffer 430 may be empty for a predetermined time. Accordingly, the resource manager 410 transits the terminal 300 from the scheduling-OFF state 512 to the dormant state 520.

Next, how the state controlling apparatus 400 transits the terminal 300 from the scheduling-OFF state 512 to the scheduling-ON state 511 will be described with reference to FIG. 10.

FIG. 10 is a flowchart showing how a state controlling apparatus 400 transits a terminal from a scheduling-OFFOFF state 512 to a scheduling-ON state 511 according to an exemplary embodiment of the present invention.

First, the terminal 300 Is in the scheduling-OFF state 512 (S501).

The scheduler 440 allocates a state transition channel to the terminal 300 in the scheduling-OFF state 512 so as to rapidly transit the terminal 300 to the scheduling-ON state 511 (S503) and the terminal 300 in the scheduling-OFF state 512 maintains a synchronization to the state transition channel.

The scheduler 440 confirms that the QoS level of the packet data of the MAC transmitting buffer 450 is higher than the threshold QoS (S505), and transits the terminal 300 to the scheduling-ON state 511 (S509). In addition, the scheduler 440 confirms that the stored packet data amount of the MAC transmitting buffer 450 and the MAC receiving buffer 460 is more than the predetermined threshold traffic amount (S507), and transits the terminal 300 to the scheduling-ON state 511 (S509).

The scheduler 440 transmits the state transition information to the terminal 300 through the state transition channel, in which the state transition information includes that the terminal is transited to the scheduling-ON state 511 (S511) such that the terminal 300 cancels the DRX scheme applied to the downlink traffic channel. In addition, the terminal 300 receives the state transition information and cancels the DRX scheme applied to the downlink traffic channel.

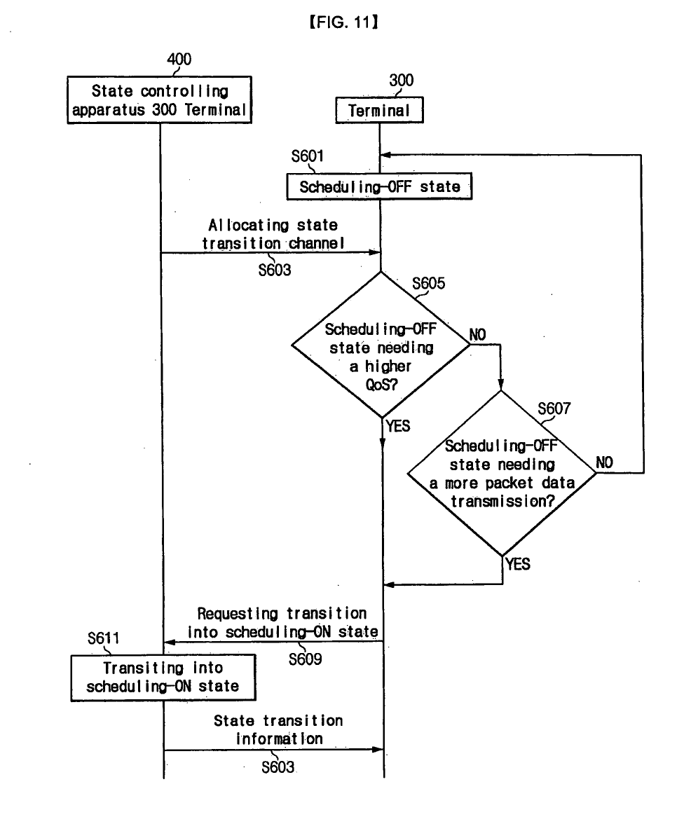

FIG. 11 is a flowchart showing how a state controlling apparatus 400 transits a terminal 300 from a scheduling-OFFOFF state 512 to a scheduling-ON state 511 according to another exemplary embodiment of the present invention.

First, the terminal 300 is in a scheduling-OFF state 512 (S601).

The scheduler 440 allocates the state transition channel to the terminal 300 in the scheduling-OFF state 512 (S603), and the terminal 300 in the scheduling-OFF state 512 maintains a synchronization to the state transition channel.

When the terminal 300 requires a higher QoS than that of the scheduling-OFF state 512 (S605), it requests the state controlling apparatus 400 to transit the terminal 300 into the scheduling-ON state 511 through the state transition channel (S609). In addition, when the terminal 300 wants to transmit more packet data than that which the terminal 300 in the scheduling-OFF state 512 can transmit to the state controlling apparatus 400 (S607), the terminal 300 requests the state controlling apparatus 400 to transit the state of the terminal 300 into the scheduling-ON state 511 through the state transition channel (S609).

When the scheduler 440 receives the state transition request to the scheduling-ON state 511 (S609), it transits the terminal 300 from the scheduling-OFF state 512 to the scheduling-ON state 511 (S611), and allocates the uplink and downlink traffic channel radio resource to the terminal 300 according to the requested QoS.

The scheduler 440 transmits the state transition information that the terminal 300 is transited into the scheduling-ON state 511 to the terminal 300 through the state transition channel (S613), and allows the terminal 300 to cancel the DRX scheme applied to the downlink traffic channel. In addition, the terminal 300 receives the state transition information and cancels the DRX scheme applied to the downlink traffic channel.

According to the exemplary embodiments of the present invention, the dormant state 520 is defined as a state in which the terminal 300 breaks a synchronization to the backward traffic channel. However, it may be defined as a state in which the terminal 300 may not transmit the packet data even though the terminal 300 maintains a synchronization to the uplink traffic channel. At this time, the state transition channel may be used so as to transmit the state transition information between the base station 220 and the terminal 300.

The state controlling apparatus 400 according to the exemplary embodiments of the present invention may be formed in the base station 220, and may be formed in the wireless network subsystem 200a of FIG. 1. In addition, the state controlling apparatus 400 according to the exemplary embodiments of the present invention may be applied to other cellular systems apart from the cellular system of FIG. 1.

The constituent elements described in the exemplary embodiments of the present invention may be realized as hardware formed with such a logic element as at least one DSP (digital signal processor), a processor, a controller, an application specific integrated circuit (ASIC), a field programmable gate array (FPGA), other electronic apparatuses, or a combination thereof. At least some functions or processes according to the exemplary embodiments of the present invention may be realized as software, which may be recorded in a recording medium. In addition, the constituent elements, functions, or processes described according to the exemplary embodiments of the present invention may be realized as a combination of hardware and software.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

According to the exemplary embodiments of the present invention, the terminal state may be controlled according to the format and QoS of the packet service, and thus it is possible to efficiently use a radio resource and to reduce power consumption. It is possible to rapidly transit the terminal state by controlling the terminal state in the data link layer.

1. A terminal state controlling method, comprising:
transiting a terminal into a dormant state when packet data are not received from the terminal in an active state for a predetermined time; and
transiting the terminal into an idle state when packet data to be transmitted to the terminal in the dormant state are not received for a predetermined time,
wherein the active state and the dormant state are states in which the uplink and downlink traffic channels are allocated to the terminal,
the active state being a state in which the terminal maintains a synchronization to the uplink and downlink traffic channels,
the dormant state being a state in which the terminal breaks the synchronization to the uplink and downlink traffic channels, and wherein
the idle state is a state In which the uplink and downlink traffic channels are not allocated to the terminal.

2. The terminal state controlling method of claim 1, wherein the dormant state is a state in which the terminal discontinuously receives the packet data through the downlink traffic channel.

3. The terminal state controlling method of claim 2, further comprising:
receiving a transition request into the active state from the terminal through a random access channel; and
transiting the terminal from the dormant state to the active state when the transition request is received.

4. The terminal state controlling method of claim 3, further comprising:
determining a random access channel resource according to the terminal-supportable QoS; and
informing the terminal of the determined random access channel resource,
wherein the receiving of the transition request into the active state comprises receiving the transition request into the active state from the terminal through the determined random access channel resource.

5. The terminal state controlling method of claim 4, wherein the informing includes informing the terminal of the determined random access channel resource through a paging channel.

6. The terminal state controlling method of claim 5, wherein the random access channel resource is a backoff time.

7. The terminal state controlling method of claim 6, further comprising transiting the terminal from the active state to the idle state when the packet data to be transmitted to the terminal are not received for the predetermined time and the packet data are not received from the terminal for the predetermined time.

8. The terminal state controlling method of claim 6, further comprising transiting the terminal from the idle state to the active state when the packet data to be transmitted to the terminal in the idle state are received.

9. The terminal state controlling method of claim 1, wherein the active state includes a first sub-state for allocating a radio resource of the uplink and downlink traffic channels to the terminal according to the terminal-supportable QoS and a second sub-state for the terminal discontinuously transmitting/receiving the packet data through the uplink and downlink traffic channels.

10. The terminal state controlling method of claim 9, further comprising transiting the terminal into the second sub-state when the QoS level of packet data to be transmitted to the terminal in the first sub-state is lower than a threshold QoS, packet data of less than a threshold value are received, and packet data of less than a threshold value to be transmitted to the terminal are received.

11. The terminal state controlling method of claim 9, further comprising transiting the terminal into the first sub-state when the QoS level of packet data to be transmitted to the terminal in the second sub-state is higher than a threshold QoS.

12. The terminal state controlling method of claim 9, further comprising transiting the terminal into the first sub-state when packet data of more than a threshold value are received from the terminal in the second sub-state.

13. The terminal state controlling method of claim 9, further comprising transiting the terminal into the first sub-state when packet data of more than a threshold value to be transmitted to the terminal in the second sub-state are received.

14. The terminal state controlling method of claim 13, further comprising:
allocating a state transition channel to the terminal in the second sub-state;
receiving a state transition request for transiting the terminal from the second sub-state to the first sub-state; and
transiting the terminal from the second sub-state to the first sub-state when the state transition request is received.

15. The terminal state controlling method of claim 14, wherein the state transition channel is a control channel of discontinuous transmitting/receiving scheme.

16. A terminal state controlling method, comprising:
transiting a terminal into a scheduling-OFF state when packet data are not received from the terminal in a scheduling-ON state for a predetermined time; and
transiting the terminal into a dormant state when packet data are not received from the terminal in the scheduling-OFF state for a predetermined time,
wherein the scheduling-ON state, the scheduling-OFF state, and the dormant state are states in which uplink and downlink traffic channels are allocated to the terminal,
the scheduling-ON state being a state in which the uplink and downlink traffic channel resources are allocated to the terminal according to the terminal-supportable QoS,
the scheduling-OFF state being a state in which the terminal discontinuously transmits/receives the packet data through the uplink and downlink traffic channels, and
the dormant state being a state in which the terminal breaks a synchronization to the uplink and downlink traffic channels.

17. The terminal state controlling method of claim 16, further comprising:
allocating a state transition channel to the terminal in the scheduling-OFF state;
receiving a state transition request for transiting the terminal from the scheduling-OFF state to the scheduling-ON state through the state transition channel; and
transiting the terminal from the scheduling-OFF state to the scheduling-ON state when the state transition request is received.

18. The terminal state controlling method of claim 16, further comprising:
determining a random access channel resource according to the terminal-supportable QoS;
informing the terminal of the determined random access channel resource through a paging channel;
receiving a transition request into the active state from the terminal in the dormant state through the determined random access channel resource; and
transiting the terminal from the dormant state to the scheduling-ON state or the scheduling-OFF state when the transition request is received.

19. The terminal state controlling method of claim 18, further comprising:
transiting the terminal to the idle state when the packet data to be
transmitted to the terminal in the dormant state are not received for the predetermined time,
wherein the idle state is a state in which the uplink and downlink traffic channels are not allocated to the terminal.

20. The terminal state controlling method of claim 18, wherein the dormant state is a state in which the terminal discontinuously receives the packet data through the downlink traffic channel.

21. A terminal state controlling apparatus comprising:
a resource manager for allocating uplink and downlink traffic channels to a terminal on the establishment of the terminal in an active state, and the terminal breaking a synchronization to the uplink traffic channel on the establishment of the terminal in a dormant state; and
a scheduler for allocating a uplink traffic channel and a downlink traffic channel resource to the terminal according to the terminal-supportable QoS when the sub-state of the terminal in the active state is established as a scheduling-ON state,
and for allowing the terminal to discontinuously receive and transmit packet data through the uplink and downlink traffic channels when the terminal in the active state has a sub-state established as a scheduling-OFF state.

22. The terminal state controlling apparatus of claim 21, further comprising:
a first receiving buffer for storing the packet data received from the terminal,
wherein the scheduler transits the terminal from the scheduling-ON state to the scheduling-OFF state when the first receiving buffer is empty for a predetermined time.

23. The terminal state controlling apparatus of claim 22, further comprising:
a first transmitting buffer for storing packet data to be transmitted to the terminal,
wherein the scheduler transits the terminal from the scheduling-ON state to the scheduling-OFF state when the first transmitting buffer has packet data of more than a predetermined reference amount.

24. The terminal state controlling apparatus of claim 23, wherein
the scheduler transits the terminal from the scheduling-ON state to the scheduling-OFF state when a QoS level of the stored packet data of the first transmitting buffer is lower than a threshold QoS level and the first receiving buffer and the first transmitting buffer have packet data of less than a predetermined reference amount.

25. The terminal state controlling apparatus of claim 23, further comprising a second receiving buffer for storing packet data received from the terminal,
wherein the resource manager transits the terminal from the active state to the dormant state when the second receiving buffer is empty for a predetermined time.

26. The terminal state controlling apparatus of claim 25, further comprising a second transmitting buffer for storing packet data to be transmitted to the terminal,
wherein the resource manager transits the terminal from the dormant state to the active state when the second transmitting buffer has packet data of more than a predetermined reference amount.

27. The terminal state controlling apparatus of claim 26, wherein
the scheduler, the first receiving buffer, and the first transmitting buffer are in a media access control (MAC) layer, and the resource manager, the second receiving buffer, and the second transmitting buffer are in a radio resource control (RRC) layer.

28. The terminal state controlling apparatus of claim 27, wherein the resource manager allows the terminal to discontinuously receive packet data though the downlink traffic channel when the terminal is established into the dormant state.

29. The terminal state controlling apparatus of claim 27, wherein the resource manager determines a random access channel resource according to the terminal-supportable QoS, and transits the terminal from the dormant state to the active state when it receives a transition request into the active state from the terminal in the dormant state through the random access channel resource.

30. The terminal state controlling apparatus of claim 27, wherein the scheduler transits the terminal from the scheduling-OFF state to the scheduling-ON state when it receives a transition request into the scheduling-ON state from the terminal in the scheduling-OFF state.

31. The terminal state controlling apparatus of claim 27, wherein the resource manager recovers the uplink and downlink traffic channels from the terminal when the terminal is established in the idle state.

32. The terminal state controlling apparatus of claim 31, wherein
the resource manager transits the terminal from the dormant state to the idle state, when the second transmitting buffer is empty for a predetermined time.

33. The terminal state controlling apparatus of claim 31, wherein
the resource manager transits the terminal from the idle state to the dormant state when the second transmitting buffer has packet data.
